(19) United States
(12) Patent Application Publication
(10) Pub. No.: US 2022/0126476 A1
(43) Pub. Date: Apr. 28, 2022

(54) Power Tool with a Dust Collection Attachment

(71) Applicant: Robert Bosch GmbH, Stuttgart (DE)

(72) Inventors: Agustin Monroy, Santa Veronica (MX); Balazs Nagy, Roselle, IL (US); Daniel Schadegg, Buffalo Grove, IL (US)

(21) Appl. No.: 17/509,575

(22) Filed: Oct. 25, 2021

Related U.S. Application Data
(60) Provisional application No. 63/106,474, filed on Oct. 28, 2020.

(51) Int. Cl. B27B 5/30; B23Q 11/00

(52) U.S. Cl. CPC B27B 5/30; B25F 5/02; B23Q 11/0071; B23Q 11/0046

(57) ABSTRACT

A power tool system comprises a power tool and a dust collection attachment. The dust collection attachment comprises an attachment portion mounted on the power tool and a dust collection tube extending alongside the attachment portion. The dust collection attachment comprises a tab configured to retain the dust collection attachment on the power tool and arranged on the dust collection tube. The power tool comprises a pocket in which the tab is located.

### TECHNICAL FIELD

This disclosure relates to the field of power tools with dust collection attachments and more particularly to oscillating power tools with dust collection attachments.

### BACKGROUND

Oscillating power tools are lightweight, handheld tools configured to oscillate various accessories. The accessories may be cutting blades, sanding discs, grinding tools, and many others. The accessories enable the oscillating power tool to shape and contour workpieces in many different ways. Various attachments such as cutting depth guides or dust collection attachments can be attached to the oscillating power tool. A user may want to mount or remove those attachments.

### SUMMARY

One aspect of this disclosure is directed to a power tool system comprising a power tool and a dust collection attachment, the dust collection attachment comprising, an attachment portion mounted on the power tool and a dust collection tube extending alongside the attachment portion, the dust collection attachment comprises a tab configured to retain the dust collection attachment on the power tool, the tab extends away from the dust collection tube, the power tool comprises a pocket, and the tab is located in the pocket.

In some embodiments, the tab has a T shape with a base portion extending away from the dust collection tube and an additional portion extending across the base portion, the pocket has a T shape corresponding to the T shape of the tab with a base portion extending away from the dust collection tube and an additional portion extending across the base portion.

In some embodiments, the tab and the attachment portion are substantially on the same side of the dust collection tube.

In some embodiments, the dust collection tube has a first axially extending section and a second axially extending section, the first axially extending section is closer to a front portion of the power tool than the second axially extending section, the attachment portion is arranged on the second axially extending section, and the tab is arranged on the first axially extending section.

In some embodiments, the first axially extending section has a first cross section, the second axially extending section has a second cross section, and the first cross section is bigger than the second cross section.

In some embodiments, the dust collection tube has a third axially extending section adjacent arranged between the first and the second axially extending sections, the third axially extending section has a third cross section, and the third cross section is smaller than the first cross section and bigger then the second cross section.

In some embodiments, the attachment portion is a collar surrounding a portion of the power tool, the collar has a first section connected with the dust collection tube, the first section has a first end portion and a second end portion, the first end portion of the first section is connected with a second section of the collar and the second section has a third end portion, the second end portion of the first section is connected with a third section of the collar and the third section has a fourth end portion, and the third end portion and the fourth end portion are connected with a fourth section of the collar.

In some embodiments, the first, second, third and fourth end portions have radially outwardly extending segments.

In some embodiments, the power tool comprises a central housing and a transmission housing, the central housing and the transmission housing have several pairs of corresponding axially aligned connection screw receptacles, the pairs are parallel to each other, the pairs of receptacles radially extend outward from the power tool, and the receptacles of the transmission housing are seated in the radially outwardly extending segments.

In some embodiments, the radially outwardly extending segments have radially inwardly extending first shoulders and wherein the first shoulders abut two of the receptacles.

In some embodiments, the third section has a radially inwardly extending second shoulder, and the second shoulder abuts a corresponding shoulder of the transmission housing.

In some embodiments, the first and second shoulders are facing the tab.

In some embodiments, the third section of the collar has a first axial length, the second section of the collar has a second axial length, and the first axial length is bigger than the second axial length.

In some embodiments, the power tool has a front portion with a flange to attach an accessory, wherein the attachment portion of the dust collection attachment is mounted adjacent to the front portion, and wherein the pocket for the tab is arranged on the front portion adjacent to the flange.

In some embodiments, the power tool comprises a central housing and a transmission housing at the front portion, and wherein the attachment portion of the dust collection attachment is mounted on the transmission housing.

In some embodiments, the power tool has an elongated shape with a central axis, the dust collection tube has a front end with an inlet for the dust and a back end with an outlet for the dust, and the inlet is closer to the central axis than the back end.

Another aspect of this disclosure is directed to a power tool system comprising a power tool and an attachment, the attachment comprising an attachment portion mounted on the power tool and an operating portion extending alongside the attachment portion and oriented towards a front portion of the power tool, wherein the attachment comprises a tab configured to retain the attachment on the power tool that is arranged on the operating portion, wherein the power tool comprises a pocket, and wherein the tab is located in the pocket.

The above aspects of this disclosure and other aspects will be explained in greater detail below with reference to the attached drawings.

### BRIEF DESCRIPTION OF THE DRAWINGS

FIG. 1 is a first perspective view of a power tool with a dust collection attachment.

FIG. 2 is a side view of a front portion of the power tool generally opposite from the first perspective view.

FIG. 3 is a bottom view of the front portion of the power tool.

FIG. 4 is a first perspective view of the dust collection attachment.

FIG. 5 is a second perspective view of the dust collection attachment.

FIG. 6 is a side view as in FIG. 2 without a dust collection system.

FIG. 7 is a side view opposite from the side view of FIG. 6.

### DETAILED DESCRIPTION

The illustrated embodiment is disclosed with reference to the drawings. However, it is to be understood that the disclosed embodiment is intended to be merely an example that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

The figures show a power tool system 10 comprising a power tool 12 and a dust collection attachment 14. The dust collection attachment 14 is removable. Instead of a dust collection attachment 14, another attachment, e.g. a cutting depth guide, may be used. In the present embodiment, the power tool 12 is an oscillating power tool. The power tool 12 may also be another power tool, in particular a hand held power tool, such as a drill or driver, a rotary hammer, a router, an angle grinder, a sander, a jig saw, a reciprocating saw, a circular saw, or a planer. The power tool 12 is powered by a battery pack 16 but may also be powered by AC power or compressed air. The battery pack 16 is attached to a back portion of the power tool 12.

In the present disclosure, the power tool 12 has the elongated shape of an oscillating power tool with a central axis 18. The power tool 12 comprises a central housing 20 and a transmission housing 22 arranged at the front portion of the power tool 12. Alternatively, the central housing may have a different shape e.g. that of a drill or driver, a rotary hammer, a router, an angle grinder, a sander, a jigsaw, a reciprocating saw, a circular saw, or a planer. An operator holds the power tool 12 by the central housing 20, typically between the battery pack 16 and the transmission housing 22. The central housing 20 comprises two shell halves 24 that generally extend along central axis 18. The shell halves 24.1, 24.2 may be made from plastic and are substantially symmetrical. The transmission housing 22 is a die cast made from metal. The power tool 12 may also be made from two shell halves that also include a transmission housing.

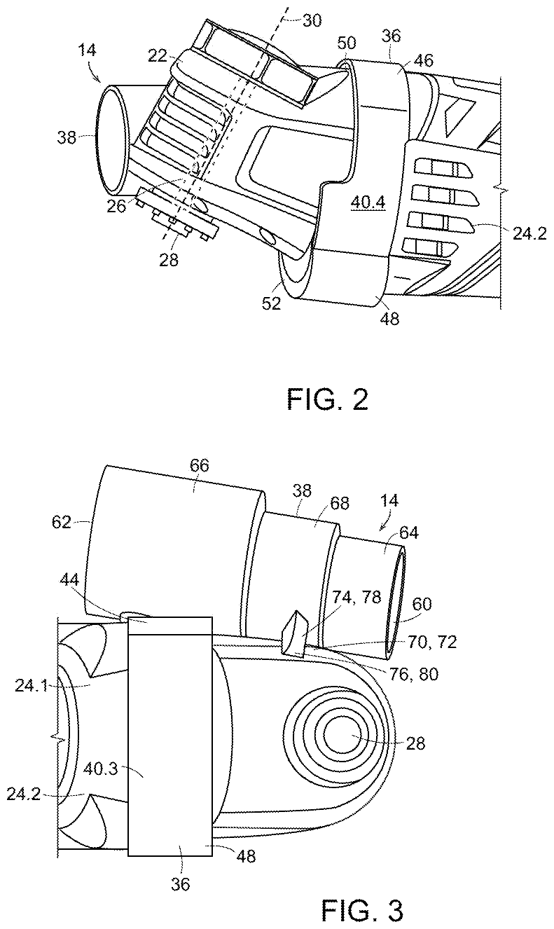

The transmission housing 22 contains an oscillating mechanism that transforms rotary movement of a motor (not shown) inside the power tool 12 into oscillating motion of an output shaft 26 (dashed lines in FIG. 2). Various accessories (not shown) such as cutting blades, sanding discs or grinding tools may be attached to a flange 28 which is attached to the output shaft 26. The flange 28 and output shaft 26 may also be a single part. The output shaft 26 and flange 28 have an oscillating axis 30.

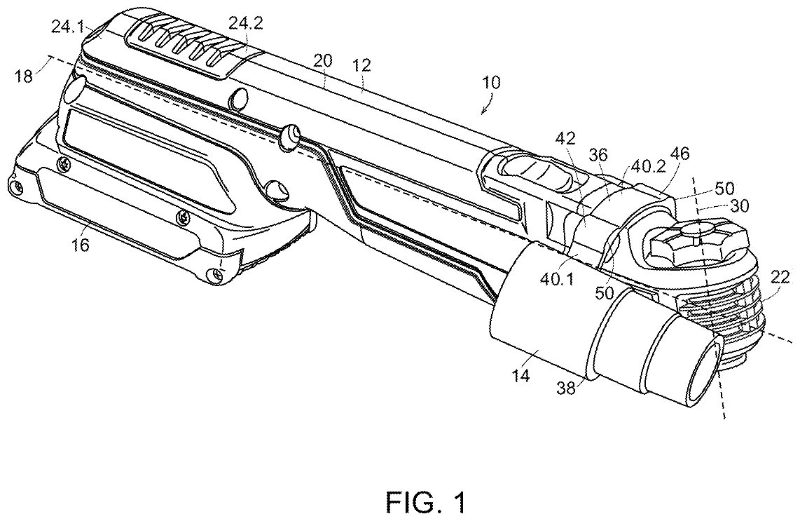

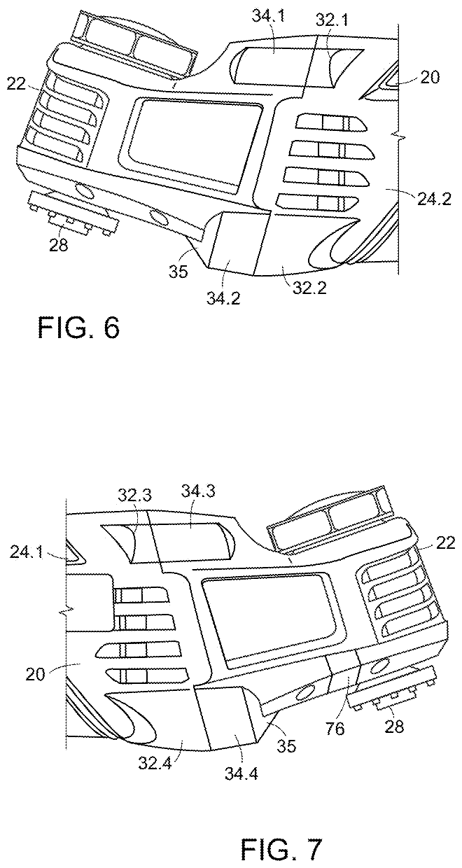

As can be seen in FIGS. 6 and 7, the central housing 20 has four connection screw receptacles 32.1, 32.2, 32.3, 32.4. The transmission housing 22 has four corresponding connection screw receptacles 34.1, 34.2, 34.3, 34.4. This results in four pairs of corresponding connection screw receptacles 32.1 and 34.1, 32.2. and 34.2, 32.3 and 34.3, 32.4 and 34.4 with each pair being aligned. The pairs 32.1 and 34.1, 32.2 and 34.2, 32.3 and 34.3, 32.4 and 34.4 are parallel to each other and radially extend outward from the power tool 12. How they extend radially outward can best be seen in FIG. 1. Finally, there is a housing shoulder 35 between receptacles 34.2 and 34.4. To connect the central housing with the transmission housing 22 screws are inserted from the front portion. The threaded bottom parts of the screws are located in the receptacles 32.1, 32.2, 32.3, 32.4 of the transmission housing 22 and the top parts with heads of the screws in the receptacles 34.1, 34.2, 34.3, 34.4 of the transmission housing 22.

The dust collection attachment 14 comprises an attachment portion 36 mounted on the power tool 12 and a dust collection tube 38 extending alongside the attachment portion 36. The dust collection attachment 14 is a single injection molded part. The attachment portion 36 and collection tube 38 may also be two separate parts that are joined together. The attachment portion 36 of the dust collection attachment 14 is mounted adjacent to the front portion of the power tool 12.

The attachment portion 36 is a collar surrounding a portion of the power tool 12. Instead of a collar the attachment portion 36 may also be a clip that partially surrounds the power tool 12. In a direction of its circumference, the collar has a first section 40.1 connected with the dust collection tube 38. The first section 40.1 has a first end portion 42 and a second end portion 44, the first end portion 42 of the first section 40.1 is connected with a second section 40.2 of the collar and the second section 40.1 has a third end portion 46. The second end portion 44 of the first section 40.1 is connected with a third section 40.3 of the collar. The third section 40.3 has a fourth end portion 48. The third end portion 46 and the fourth end portion 48 are connected with a fourth section 40.4 of the collar. The first, second, third and fourth end portions 42, 44, 46, 48 have radially outwardly extending segments. The radially outwardly extending segments are seats for the receptacles 34.1, 34.2, 34.3, 34.4 of the transmission housing 22. The radially outwardly extending segments of the end portions 42, 44, 46, 48 each have a radially inwardly extending first shoulder 50. The radially inwardly extending first shoulders 50 axially abut the receptacles 34.1, 34.2, 34.3, 34.4. The third section 40.3, between the end portions 44 and 48, has a radially inwardly extending second shoulder 52.

The third section 40.3 of the collar has a first axial length 54.1. The second section 40.2 of the collar has a second axial length 54.2. The first axial length 54.1 is bigger than the second axial length 54.2 (FIG. 5). An axial length of the first section 40.1 and fourth section 40.4 adjacent the third section 40.2 is the same as the first axial length 54.1. An axial length of the first section 40.1 and fourth section 40.4 adjacent the second section 40.2 is the same as the second axial length 54.2. The dust collection tube 38 spans the axial lengths of the first section 40.1. A step 56 spans the axial lengths of the fourth section 40.4. The axial lengths are generally parallel to the central axis 18.

The dust collection tube 38 has a front end with an inlet 60 for dust and a back end with an outlet 62 for dust. At the inlet 60, further dust collection devices may be attached. At the outlet 62, a vacuum hose may be attached. The inlet 60 points towards a location in front of the power tool 12 Where an accessory may create dust. The inlet 60 is closer to the central axis 18 than the outlet 62. The dust collection tube 38 has a first axially extending section 64, a second axially extending section 66 and may have a third axially extending section 68. The first axially extending 64 is arranged at the front end or inlet 60. The second axially extending section 66 is arranged at the back end or outlet 62 of the tube 38. The third axially extending section 68 is arranged between the first section 64 and second section 66. The first section 64 has a first cross section and the second section 66 has a second cross section. The first cross section may be bigger than the second cross section. The third section has a third cross section that is bigger than the first cross section and smaller than the second cross section. The attachment portion 36 is arranged on the second axially extending section 66. The cross section may be the same size.

The dust collection attachment 14 further comprises a tab 70 configured to retain the dust collection attachment 14 on the power tool 12. It extends away from the dust collection tube 38, in particular the first axially extending section 64. The tab 70 and the attachment portion 36 are both located on the side of the dust collection tube 38 facing the power tool 12. The tab 70 has a T shape with a base portion 74 connected to the dust collection tube 38 and an additional portion 76 extending across the first portion 74. The base portion 74 is connected with the dust collection tube 38. The power tool 12 comprises a corresponding pocket 72 in which the tab 70 is located. The pocket 72 is arranged on the front portion of the power tool 12 adjacent to the flange 28. The pocket 72 has a T shape with a base portion 78 of the pocket 72 facing the dust collection tube 38 and an additional portion 80 away from the tube 38 and extending across the end of the first portion 78 of the pocket 72. The base portion 74 of the tab 70 is located in the base portion 78 of the pocket 72 and the additional portion 76 of the tab 70 is located in the additional portion 80 of the pocket 72.

For mounting the dust collection attachment 14, the power tool 12 is inserted with the front portion, or the transmission housing 22, first into the attachment portion 36. The first shoulders 50 and the second shoulders 52 of the attachment portion 36 have to face the tab 70 to insure proper mounting. The attachment portion 36 of the dust collection attachment is mounted adjacent to the front portion of the power tool 12. In the present embodiment, the attachment portion 36 of the dust collection attachment 14 is mounted on the transmission housing 22 of the power tool 12. The power tool 12 is further moved into the attachment portion 36 so that the receptacles 34.1, 34.2, 34.3, 34.4 of the transmission housing 22 slide into the radially outwardly extending segments of the first, second, third and fourth end portions 42, 44, 46, 48. Then the first shoulders 50 abut the receptacles 34.1, 34.2, 34.3, 34.4 of the transmission housing 22, and the second shoulder 52 abuts the corresponding housing shoulder 35 of the transmission housing 22. In this position, the tab 70 slides into the pocket 72 and secures the dust collection attachment 14 on the power tool 12. This is possible because the dust collection tube 38 is flexible and can twist enough to allow that movement. To remove the dust collection attachment 14 from the power tool 12 the dust collection tube is twisted until the tab 70 slides out of the pocket 72. Then the dust collection attachment can be pulled away from the power tool 12.

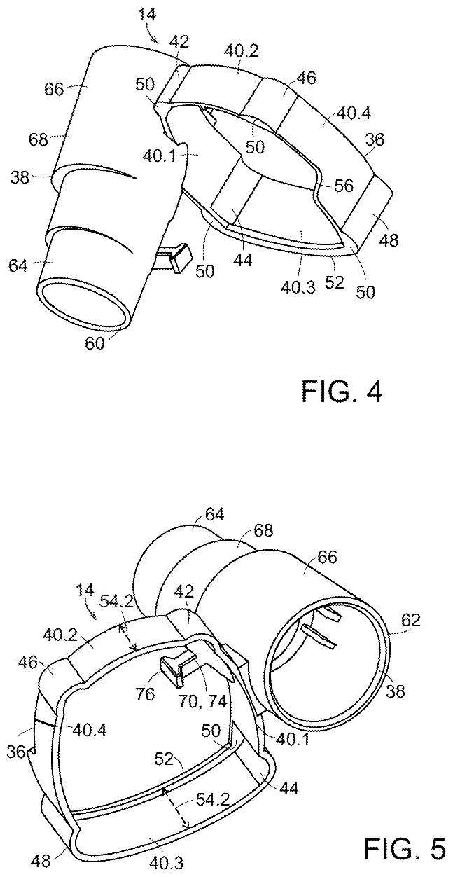

As mentioned above, the power tool system may comprise a power tool and an attachment other than a dust collection attachment. The depicted dust collection tube 38 may also be another operating portion such as a cutting depth guide. The depiction in the FIGS. 1-5 could be the same. Such an attachment comprises an attachment portion mounted on the power tool and an operating portion extending alongside the attachment portion and oriented towards a front portion of the power tool. The attachment comprises a tab configured to retain the attachment on the power tool that is arranged on the operating portion, wherein the power tool comprises a pocket, and wherein the tab is located in the pocket.

What is claimed is:

1. A power tool system comprising a power tool and a dust collection attachment, the dust collection attachment comprising, an attachment portion mounted on the power tool and a dust collection tube extending alongside the attachment portion, wherein the dust collection attachment comprises a tab configured to retain the dust collection attachment on the power tool, wherein the tab extends away from the dust collection tube, wherein the power tool comprises a pocket, and wherein the tab is located in the pocket.

2. The power tool system of claim 1, wherein the tab has a T shape with a base portion extending away from the dust collection tube and an additional portion extending across the base portion, wherein the pocket has a T shape corresponding to the T shape of the tab with a base portion extending away from the dust collection tube and an additional portion extending across the base portion.

3. The power tool system of claim 2, wherein the tab and the attachment portion are substantially on the same side of the dust collection tube.

4. The power tool system of claim 1, wherein the dust collection tube has a first axially extending section and a second axially extending section, wherein the first axially extending section is closer to a front portion of the power tool than the second axially extending section, wherein the attachment portion is arranged on the second axially extending section, and wherein the tab is arranged on the first axially extending section.

5. The power tool system of claim 4, wherein the first axially extending section has a first cross section, wherein the second axially extending section has a second cross section, and wherein the first cross section is bigger than the second cross section.

6. The power tool system of claim 5, wherein the dust collection tube has a third axially extending section adjacent arranged between the first and the second axially extending sections, the third axially extending section has a third cross section, and the third cross section is smaller than the first cross section and bigger then the second cross section.

7. The power tool system of claim 1, wherein the attachment portion is a collar surrounding a portion of the power tool, wherein the collar has a first section connected with the dust collection tube, wherein the first section has a first end portion and a second end portion, wherein the first end portion of the first section is connected with a second section of the collar and the second section has a third end portion, wherein the second end portion of the first section is connected with a third section of the collar and the third section has a fourth end portion, and wherein the third end portion and the fourth end portion are connected with a fourth section of the collar.

8. The power tool system of claim 7, wherein the first, second, third and fourth end portions have radially outwardly extending segments.

9. The power tool system of claim 8, wherein the power tool comprises a central housing and a transmission housing, wherein the central housing and the transmission housing have several pairs of corresponding axially aligned connection screw receptacles, wherein the pairs are parallel to each other, wherein the pairs of receptacles radially extend outward from the power tool, and wherein the receptacles of the transmission housing are seated in the radially outwardly extending segments.

10. The power tool system of claim 9, wherein the radially outwardly extending segments have radially inwardly extending first shoulders and wherein the first shoulders abut two of the receptacles.

11. The power tool system of claim 10, wherein the third section has a radially inwardly extending second shoulder, and wherein the second shoulder abuts a corresponding shoulder of the transmission housing.

12. The power tool system of claim 11, wherein the first and second shoulders are facing the tab.

13. The power tool system of claim 7, wherein the third section of the collar has a first axial length, wherein the second section of the collar has a second axial length, and wherein the first axial length is bigger than the second axial length.

14. The power tool system of claim 1, wherein the power tool has a front portion with a flange to attach an accessory, wherein the attachment portion of the dust collection attachment is mounted adjacent to the front portion, and wherein the pocket for the tab is arranged on the front portion adjacent to the flange.

15. The power tool system of claim 1, wherein the power tool comprises a central housing and a transmission housing at the front portion, and wherein the attachment portion of the dust collection attachment is mounted on the transmission housing.

16. The power tool system of claim 1, wherein the power tool has an elongated shape with a central axis, wherein the dust collection tube has a front end with an inlet for the dust and a back end with an outlet for the dust, and wherein the inlet is closer to the central axis than the back end.

17. A power tool system comprising a power tool and an attachment, the attachment comprising an attachment portion mounted on the power tool and an operating portion extending alongside the attachment portion and oriented towards a front portion of the power tool, wherein the attachment comprises a tab configured to retain the attachment on the power tool that is arranged on the operating portion, wherein the power tool comprises a pocket, and wherein the tab is located in the pocket.
